(19) United States
(12) Patent Application Publication
(10) Pub. No.: US 2025/0255307 A1
(43) Pub. Date: Aug. 14, 2025

(54) ANTIMICROBIAL COMPOSITION

(71) Applicant: MIDLAB, INC., Athens, TN (US)

(72) Inventors: Don Euel REYNOLDS, Lenoir City, TN (US); Matthew Jon SCHENK, Athens, TN (US); Courtney Elaine COSNER, Athens, TN (US)

(73) Assignee: MIDLAB, INC., Athens, TN (US)

(21) Appl. No.: 19/032,773

(22) Filed: Jan. 21, 2025

Related U.S. Application Data
(60) Provisional application No. 63/551,116, filed on Feb. 8, 2024.

(51) Int. Cl. A01N 59/00; A01N 25/02; A01N 25/30; A01P 1/00

(52) U.S. Cl. CPC A01N 59/00; A01N 25/02; A01N 25/30; A01P 1/00

(57) ABSTRACT

A disinfectant concentrate and composition that is devoid of phosphoric acid and beta hydroxy acid. The disinfectant composition includes: (a) about 0.0278 to about 0.6365 wt. % hydrogen peroxide based on a total weight of the composition; (b) a chelating agent in an amount ranging from about 0.0013 to about 0.388 wt. % based on a total weight of the composition; (c) a dispersant in an amount ranging from about 0.006 to about 0.108 wt. % based on a total weight of the composition; (d) about 0.004 to about 1.255 wt. % of an acidulate based on a total weight of the composition; (e) a solvent in an amount ranging from about 0.0016 to about 1.452 wt. % based on a total weight of the composition; (f) a surfactant in an amount ranging from about 0.0031 to about 2.29 wt. % based on a total weight of the composition; and (g) the balance deionized water.

### RELATED APPLICATION

This application is a non-provisional application that claims priority to provisional application Serial No.: 63/551,116, filed Feb. 8, 2024, now pending.

### TECHNICAL FIELD

This disclosure relates to the field of antimicrobial and disinfectant compositions that are free of phosphorus-containing compounds and beta hydroxy acids. More specifically, the invention relates to a composition utilizing hydrogen peroxide to provide high antimicrobial efficacy and prevent local environmental bacterial growth and virucidal activity despite the absence of phosphoric acid and beta hydroxy acid.

### BACKGROUND AND SUMMARY

Today, there is a wide variety of antimicrobial and disinfection agents which may be used for any number of purposes. In recent years, much focus has been placed on the development and use of safer and more environmentally friendly chemical-based antimicrobial and disinfection agents that have been thoroughly studied and certified for use through programs like the Environmental Protection Agency's Safer Choice program. These safer disinfecting products eliminate risks of harmful exposure and other adverse effects associated with traditional disinfection agents when used on common contact surfaces in schools, hospitals, workplaces, and many other environments where the effective disinfection and the prevention of further contamination is critical.

Many of the disinfection agents certified for use through programs such as the Safer Choice program are, by themselves, less effective than traditional agents or demonstrate less than optimal disinfecting and antimicrobial qualities when substituted into traditional formulas. Accordingly, what is desired is an improved antimicrobial composition using safer antimicrobial and disinfection agents that, together, are highly effective, stable, low cost, and easily manufactured.

In view of the foregoing, an embodiment of the disclosure provides a disinfectant concentrate and composition that is devoid of phosphoric acid and beta hydroxy acid. The concentrate and composition include a mixture of:
(a) about 1.75 to about 10.50 wt. % hydrogen peroxide based on a total weight of the concentrate;
(b) one or more chelating agents in an amount ranging from about 0.08 to about 6.40 wt. % based on a total weight of the concentrate;
(c) one or more dispersants in an amount ranging from about 0.04 to about 1.78 wt. % based on a total weight of the concentrate;
(d) one or more acidulates in an amount ranging from about 0.25 to about 20.70 wt. % based on a total weight of the concentrate;
(e) one or more solvents in an amount ranging from about 0.10 to about 24.00 wt. % based on a total weight of the concentrate;
(f) one or more surfactants in an amount ranging from about 0.20 to about 36.84 wt. % based on a total weight of the concentrate; and
(g) the balance water.

In some embodiments, at least one of the surfactants is an anionic surfactant. In other embodiments, at least one of the surfactants is a nonionic surfactant. In still other embodiments, the surfactants include a mixture of anionic and nonionic surfactants.

In another embodiment, there is provided a disinfectant composition that is devoid of phosphoric acid and beta hydroxy acid including dilution water and a disinfectant concentrate composition including a mixture of:
(a) about 0.0278 to about 0.6365 wt. % hydrogen peroxide based on a total weight of the disinfectant composition;
(b) one or more chelating agents in an amount ranging from about 0.0013 to about 0.388 wt. % based on a total weight of the disinfectant composition;
(c) one or more dispersants in an amount ranging from about 0.006 to about 0.108 wt. % based on a total weight of the disinfectant composition;
(d) one or more acidulates in an amount ranging from about 0.004 to about 1.255 wt. % based on a total weight of the disinfectant composition;
(e) one or more solvents in an amount ranging from about 0.0016 to about 1.45 wt. % based on a total weight of the disinfectant composition;
(f) one or more surfactants in an amount ranging from about 0.0031 to about 2.23 wt. % based on a total weight of the disinfectant composition; and
(g) the balance deionized water.

In some embodiments, the disinfectant concentrate composition is about 1.6 wt. % based on a total weight of the disinfectant composition.

In another embodiments, the disinfectant concentrate composition includes about 59 milliliters of disinfectant concentrate composition diluted in 3.8 liters of deionized water. In some embodiments, the disinfectant concentrate composition includes between about 59 to about 237 milliliters of disinfectant concentrate composition diluted in 3.8 liters of deionized water.

In another embodiment, there is provided a method for disinfecting surface that includes applying to the surfaces an effective amount of the disinfectant composition that includes the following:
(a) about 0.0278 to about 0.6365 wt. % hydrogen peroxide based on a total weight of the disinfectant composition;
(b) one or more chelating agents in an amount ranging from about 0.0013 to about 0.388 wt. % based on a total weight of the disinfectant composition;
(c) one or more dispersants in an amount ranging from about 0.006 to about 0.108 wt. % based on a total weight of the disinfectant composition;
(d) one or more acidulates in an amount ranging from about 0.004 to about 1.255 wt. % based on a total weight of the disinfectant composition;
(e) one or more solvents in an amount ranging from about 0.0016 to about 1.45 wt. % based on a total weight of the disinfectant composition;
(f) one or more surfactants in an amount ranging from about 0.0031 to about 2.23 wt. % based on a total weight of the disinfectant composition; and
(g) the balance deionized water.

### DETAILED DESCRIPTION

For the purpose of this disclosure, all amounts and weight percents are given on the basis of active ingredient unless otherwise noted.

The disinfectant concentrate compositions described herein generally include a major portion of hydrogen peroxide, surfactant, solvent, acidulate, chelating agent, and dispersant.

Compositions described herein are devoid of phosphorus containing compounds such as phosphoric acid, as well as beta hydroxy acids, notably salicylic acid. In some embodiments, the disinfectant concentrate composition may be diluted to provide a disinfectant composition. In other embodiments, the disinfectant concentrate composition may be used in a concentrated form as a ready-to-use composition.

Among the constituents of the antimicrobial concentrate, there is present a major amount of hydrogen peroxide. The hydrogen peroxide in combination with the other components of the disinfectant concentrate composition provides a surprising and unexpected level of antimicrobial action against organisms including, but not limited to Staphylococcus aureus bacteria.

### Hydrogen Peroxide

Hydrogen peroxide (H₂O₂) has a molecular weight of 34.014 and is a weakly acidic, clear, colorless liquid. The four atoms are covalently bound in a nonpolar H—O—O—H structure. Generally, hydrogen peroxide has a melting point of −0.41° C., a boiling point of 150.2° C., a density at 25° C. of 1.4425 grams per cm³ and a viscosity of 1.245 centipoise at 20° C. In some instances, hydrogen peroxide may be provided through industrial products such as MODEL B-CAP 35 MUP (35% Active) by PeroxyChem, LLC (now Evonik Active Oxygens, LLC).

While many oxidizing agents may be used, hydrogen peroxide is generally preferred for a number of reasons. First, when combined with the other ingredients listed above at the intended concentrations, hydrogen peroxide contributes to a surprising antimicrobial efficacy many times that of either constituent used separately or other hydrogen peroxide mixtures, including mixtures containing phosphoric acid.

Generally, the concentration of hydrogen peroxide within the concentrate ranges from about 1.75 to about 10.50 wt. % hydrogen peroxide based on a total weight of the concentrate. Disinfectant compositions containing the concentrate may have an effective amount of hydrogen peroxide, ranging from about 0.0278 to about 0.6365 wt. % based on a total weight of the disinfectant composition.

These concentrations of hydrogen peroxide may be increased or decreased while still remaining within the scope of the present disclosure. For example, increasing the concentration of hydrogen peroxide may increase the antimicrobial efficacy of the composition of the present invention. Furthermore, increasing the H₂O₂ concentration may reduce the need to stabilize the hydrogen peroxide within the composition. Specifically, increasing the hydrogen peroxide concentration in the composition may provide a composition which has an extended shelf life. However, increasing the concentration of hydrogen peroxide past a certain level may be undesirable.

In contrast, decreasing the concentration of hydrogen peroxide may decrease the antimicrobial efficacy of the composition and necessitate the use of an increased concentration of other antimicrobial components of the composition. Moreover, decreasing the concentration of hydrogen peroxide may necessitate the use of some stabilizing agent to ensure that the composition of the present invention will remain stable over the intended time period.

### Acidulates

The addition of a minor amount of acidulate in combination with hydrogen peroxide surprisingly and unexpectedly enhances the bactericidal and virucidal activity of aqueous hydrogen peroxide solutions. Acidulates may be selected from a wide variety of carboxylic acids individually or in combination including, but not limited to, C₄-C₆-dicarboxylic acids, itaconic acid, pyridine-2,6-carboxylic acid, pentahydroxy caproic acid, lactic acid, and hydroxy acetic acid, pentahydroxy caproic acid, and lactic acid. The amount of acidulate in the concentrate is about 0.25 to about 20.70 wt. % based on a total weight of the concentrate. In some instances, the preferred acidulate(s) may be gluconic acid provided through industrial products such as PMP Gluconic Acid (50% active) by PMP Fermentation Products, Inc, lactic acid such as PURAC HS 88 by Corbion N.V., and/or 70% active glycolic acid, available from a number of manufacturers, or mixtures thereof.

### Chelating Agent

In order to stabilize the concentrate for use in hard water applications, a chelation agent or stabilizer may be used to achieve peroxide stability. Chelating agents may be selected from a wide variety of compounds including, but not limited to, various polymers such as alkoxylated polyethyleneimine and the like. Stabilizing properties are particularly important in respect of solutions containing higher concentrations of hydrogen peroxide which tend to break down quickly. Compositions according to the disclosure are desirably devoid of phosphoric acid and have a chelating agent concentration ranging from about 0.08 to about 6.40 wt. % based on a total weight of the concentrate. In some instances, the preferred chelating agent may be ethoxylated polyethyleneimine provided through industrial products such as SOKALAN HP 20 (80% active) and SOKALAN HP 30 Booster (80% active), and a trisodium salt of methylglycinediacetic acid (MGDA) provided through industrial products such as TRILON M (40% active), all by BASF Corporation, and mixtures thereof.

### Dispersants

The concentrate may also contain one or more dispersants. Suitable dispersants include, but are not limited to 2-propenoic acid, telomer with sodium hydrogen sulfite sodium salt; polyacrylic acid modified sodium salt; acrylic homopolymer (2000 MW); maleic multipolymer; carboxylic sulphonated non-ionic terpolymer; sulfonated acrylic copolymer; acrylic homopolymer (4500 MW); maleic copolymer (4500 MW); sodium alkyl naphthalene sulfonate; and the like. The concentrate may contain from about 0.04 to about 0.98 wt. % of one or more dispersants based on a total weight of the concentrate. In some instances, a mixture of multiple dispersants may result in a percentage of dispersant exceeding about 0.98 wt. %, up to a combined amount of about 1.78 wt. % based on a total weight of the concentrate. In some instances, the preferred dispersants may be a mixture of acrylic acid homopolymer and maleic acid and telomer with sodium hydrogen sulfite, sodium salt provided through industrial products such as SOKALAN PA 25 CL (49% active) and SOKALAN CP 50 (40% active), respectively, by BASF Corporation.

### Surfactants

One or more surfactants may be used in the antimicrobial compositions described herein. In one embodiment, the surfactant includes a mixture of an anionic surfactant and a nonionic surfactant. The anionic surfactant may be selected from carboxylates, sulfonates, and sulfate solubilizing compounds having an alkyl chain ranging from about C₅ to about C₃₀.

For example, the compositions described herein may include carboxylate surfactants such as polyalkyloxycarboxylates and N-acylsarcosinates; useful sulfonates include alkylaryl sulfonates, alpha olefin sulfonates, and sulfonates with an ester, amide or ether linkages; useful sulfate wetting agents include sulfated alcohols, and sulfated alcohol ethoxylates, sulfated alkylphenols, sulfated acid, amides, and esters, sulfated natural oils and fats as well as agents such as the dioctyl ester of sodium sulfosuccinic acid.

Other surfactants may include octyldimethylamine oxide, decylamine oxide, lauryl hydroxysultaine, disodium ethylhexyliminodipropionate, disodium cocoamphodipropionate, non-ionic surfactants and cationic surfactants, cocamidopropylamine oxide, ethoxylated-propoxylated linear and branched alcohols, sodium laurimodipropionate, cocamidopropyl betaine, laureth-6 carboxylic acid, capryleth-9 carboxylic acid, 2, 5, 8, 11-tetramethyl-6-dodecyn-5,8-diol ethoxylate, isotridecyloxypropyl bis-(2-hydroxylethyl) methyl ammonium chloride, sodium C₁₂-C₁₅ alkoxypropyl iminodipropionate, sodium N-(2-carboxyethyl)-N-(2-ethylhexyl)-beta-alaninate; and 2-octyl-2-pyrrolidone. Especially preferable are anionic surfactants such as alkyl or alkyl aromatic sulfonates and sulfates such as alkylbenzene sulfate and sulfonate, and linear alkyl sulfates having an alkyl chain ranging in length from C₆ to C₂₀. Particularly preferred anionic surfactants are dodecylbenzene sulfonic acid provided through industrial products such as 98% active DDBSA by Stepan Company and capryleth-9 carboxylic acid provided through industrial products such as AKYPO LF2 by Kao Chemicals and mixtures thereof.

The nonionic surfactant may include one or more alkylated alkoxylate surfactants, such as polyoxyethylene surfactants. Suitable polyoxyethylene surfactants may be selected from alkyl polyoxyethylene surfactants and alkyl aryl polyoxyethylene surfactants. Preferred non-ionic surfactants are primary alcohol ethoxylates such as a C₉-C₁₀ alkyl compound containing an average 3.5 moles of ethylene oxide (EO) provided through industrial products such as ALFONIC 610-3.5 Ethoxylate 100% Active by Sasol Chemicals, and a C₉-C₁₁ alkyl compound containing an average 6 moles of ethylene oxide (EO) provided through industrial products such as TERGITOL 91-6 Surfactant by DOW Chemical Company, as well as secondary alcohol ethoxylates in both a substantially pure C₁₂-C₁₄ alkyl formulation, such as TERGITOL 15-S-3 Surfactant, and compounds containing C₁₂-C₁₄ alkyl and poly (ethylene oxide), such as TERGITOL™ 15-S-9 Surfactant, both by DOW Chemical Company. Also, preferred alkyl aryl polyoxyethylene surfactants that are C₈ to C₁₆ alkylphenol alkoxylates. Generally, the concentrates described herein may contain about 0.20 to about 36.84 wt. % of an anionic surfactant, non-ionic surfactant, or mixture thereof based on a total weight of the concentrate.

### Solvents

Solvents such as ketone mixtures, butyl 3-hydroxybutyrate, ethyl alcohol, methyl-5-(dimethylamino)-2-methyl-5-oxopentanoate; isoparaffinic hydrocarbons, methyl L-lactate, ethyl L-lactate, as well as glycol ethers such as propylene glycol n-butyl ether and propylene glycol n-propyl ether may be used as solvents. Preferred as solvents for use in the compositions described herein are glycol ethers having the general structure Ra—O—Rb—OH, wherein Ra is an alkoxy of 1 to 20 carbon atoms, or aryloxy of at least 6 carbon atoms, and Rb is an ether condensate of propylene glycol and/or ethylene glycol having from 1 to 10 glycol monomer units. Examples of preferred glycol ethers include ethylene glycol monobutyl ether, diethylene glycol monobutyl ether, propylene glycol monomethyl ether, propylene glycol phenyl ether, as well as butoxypropanol, propoxypropanol, mono-, di- and tri-propylene glycol n-butyl ether, propylene glycol butyl ethers, and mixtures thereof.

Desirably, one or more of the glycol ether solvents is preferably present in the concentrate in an amount ranging from about 0.10 to about 24.00 wt. % based on a total weight of the concentrate. In some instances, the preferred solvents may be a mixture of two or more of propylene glycol n-butyl ether, propylene glycol n-propyl ether, and dipropylene glycol n-butyl ether provided through industrial products such DOWANOL PNB, DOWANOL PNP, and DOWANOL DPNB respectively, by DOW Chemical Company. The solvent present in the compositions described herein have been found to provide enhanced cleaning but are not present in excessive amounts which may reduce the overall stability of the cleaning and disinfecting compositions being taught herein.

The present composition may also contain any other number of constituents such as fragrances, among other constituents which are well known to those skilled in the art and which may facilitate the activity of the present invention.

The following non-limiting exemplary formulations may be used as an antimicrobial concentrate which may be diluted in water to provide a disinfectant composition or may be used as a ready to use composition without any further dilution in water. When diluted in water, a typical dilution rate in water ranges from about 30 milliliters to about 591 milliliters of concentrate added to 3.8 liters of water.

Example Formula 1

| | Wt. % |
|---|---|
| | (Based on a total weight of |
| | the concentrate and 100 wt. % |
| Raw Material | active ingredients) |
| Deionized Water | 67.8 |
| One or more chelating agents | 0.8 |
| One or more dispersants | 0.4 |
| One or more acidulates | 5.0 |
| One or more solvents | 8.0 |
| Hydrogen Peroxide | 6.1 |
| One or more surfactants | 11.9 |

While all formulas disclosed herein are effective, a dilute concentration of the above Formula 1 was tested to determine the effectiveness of the formulation on Staphylococcus aureus (ATCC 6538). One part of the concentrate above as diluted with 63 parts of 400 ppm of AOAC synthetic hard water. The exposure time was 9 minutes 45 seconds at 20° C. The neutralizer was a Letheen Broth plus 1.0 wt. % sodium thiosulfate. The soil load used was 5 wt. % fetal bovine serum. The initial Staphylococcus aureus population was 9.12×106 (6.96 Log₁₀) CFU/carrier. Use of the composition resulted in a Staphylococcus aureus population of less than 2.51 101 (<1.40 Log₁₀) CFU/carrier providing greater than 99.99972% reduction.

Other non-limiting examples of disinfectant concentrates that may be used according to embodiments of the disclosure include the following examples.

Example Formula 2

| | Wt. % |
|---|---|
| | (Based on a total weight of the concentrate |
| Raw Material | and 100 wt. % active ingredients) |
| Deionized Water | 70.4 |
| One or more chelating agents | 0.8 |
| One or more dispersants | 0.24 |
| One or more acidulates | 5.28 |
| One or more solvents | 8.0 |
| Hydrogen Peroxide | 4.38 |
| One or more surfactants | 10.9 |

Example Formula 3

| | Wt. % |
|---|---|
| | (Based on a total weight of the concentrate |
| Raw Material | and 100 wt. % active ingredients) |
| Deionized Water | 69.96 |
| One or more chelating agents | 0.4 |
| One or more dispersants | 0.49 |
| One or more acidulates | 5.14 |
| One or more solvents | 8.0 |
| Hydrogen Peroxide | 5.25 |
| One or more surfactants | 10.76 |

Example Formula 4

| | Wt. % |
|---|---|
| | (Based on a total weight of the concentrate |
| Raw Material | and 100 wt. % active ingredients) |
| Deionized Water | 67.62 |
| One or more chelating agents | 0.8 |
| One or more dispersants | 0.25 |
| One or more acidulates | 5.28 |
| One or more solvents | 8.0 |
| Hydrogen Peroxide | 6.65 |
| One or more surfactants | 11.4 |

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A disinfectant concentrate and composition that is devoid of phosphoric acid and beta hydroxy acid comprising a mixture of:
(a) about 1.75 to about 10.50 wt. % hydrogen peroxide based on a total weight of the concentrate;
(b) one or more chelating agents in an amount ranging from about 0.08 to about 6.40 wt. % based on a total weight of the concentrate;
(c) one or more dispersants in an amount ranging from about 0.04 to about 1.78 wt. % based on a total weight of the concentrate;
(d) one or more acidulates in an amount ranging from about 0.25 to about 20.70 wt. % based on a total weight of the concentrate;
(e) one or more solvents in an amount ranging from about 0.10 to about 24.00 wt. % based on a total weight of the concentrate;
(f) one or more surfactants in an amount ranging from about 0.20 to about 36.84 wt. % based on a total weight of the concentrate; and
(g) the balance water.

2. The disinfectant concentrate composition of claim 1, wherein at least one of the surfactants comprises an anionic surfactant.

3. The disinfectant concentrate composition of claim 1, wherein at least one of the surfactants comprises a nonionic surfactant.

4. The disinfectant concentrate composition of claim 1, wherein the surfactants comprise a mixture of anionic and nonionic surfactants.

5. A disinfectant composition that is devoid of phosphoric acid and beta hydroxy acid comprising dilution water and a disinfectant concentrate composition comprising a mixture of:
(a) about 0.0278 to about 0.6365 wt. % hydrogen peroxide based on a total weight of the disinfectant composition;
(b) one or more chelating agents in an amount ranging from about 0.0013 to about 0.388 wt. % based on a total weight of the disinfectant composition;
(c) one or more dispersants in an amount ranging from about 0.006 to about 0.108 wt. % based on a total weight of the disinfectant composition;
(d) one or more acidulates in an amount ranging from about 0.004 to about 1.255 wt. % based on a total weight of the disinfectant composition;
(e) one or more solvents in an amount ranging from about 0.0016 to about 1.45 wt. % based on a total weight of the disinfectant composition;
(f) one or more surfactants in an amount ranging from about 0.0031 to about 2.23 wt. % based on a total weight of the disinfectant composition; and
(g) the balance deionized water.

6. The disinfectant composition of claim 5, wherein the disinfectant concentrate composition comprises about 1.6 wt. % based on a total weight of the disinfectant composition.

7. The disinfectant composition of claim 5, wherein the disinfectant concentrate composition comprises about 59 milliliters of disinfectant concentrate composition diluted in 3.8 liters of deionized water.

8. The disinfectant composition of claim 5, wherein the disinfectant concentrate composition comprises between about 59 to about 237 milliliters of disinfectant concentrate composition diluted in 3.8 liters of deionized water.

9. The disinfectant concentrate composition of claim 5, wherein at least one of the surfactants comprises an anionic surfactant.

10. The disinfectant concentrate composition of claim 5, wherein at least one of the surfactants comprises a nonionic surfactant.

11. The disinfectant concentrate composition of claim 5, wherein the surfactants comprise a mixture of anionic and nonionic surfactants.

12. A method for disinfecting surfaces comprising applying an effective amount of the disinfectant composition comprising dilution water and a disinfectant concentrate composition comprising a mixture of:
(a) about 0.0278 to about 0.6365 wt. % hydrogen peroxide based on a total weight of the disinfectant composition;
(b) one or more chelating agents in an amount ranging from about 0.0013 to about 0.388 wt. % based on a total weight of the disinfectant composition;
(c) one or more dispersants in an amount ranging from about 0.006 to about 0.108 wt. % based on a total weight of the disinfectant composition;
(d) one or more acidulates in an amount ranging from about 0.004 to about 1.255 wt. % based on a total weight of the disinfectant composition;
(e) one or more solvents in an amount ranging from about 0.0016 to about 1.45 wt. % based on a total weight of the disinfectant composition;
(f) one or more surfactants in an amount ranging from about 0.0031 to about 2.23 wt. % based on a total weight of the disinfectant composition; and
(g) the balance deionized water.

13. The method of claim 12, wherein the disinfectant concentrate composition comprises about 1.6 wt. % based on a total weight of the disinfectant composition.

14. The method of claim 12, wherein the disinfectant concentrate composition comprises about 59 milliliters of disinfectant concentrate composition diluted in 3.8 liters of deionized water.

15. The method of claim 12, wherein the disinfectant concentrate composition comprises between about 59 to about 237 milliliters of disinfectant concentrate composition diluted in 3.8 liters of deionized water.

16. The method of claim 12, wherein at least one of the surfactants comprises an anionic surfactant.

17. The method of claim 12, wherein at least one of the surfactants comprises a nonionic surfactant.

18. The method of claim 12, wherein the surfactants comprise a mixture of anionic and nonionic surfactants.
